(19) United States
(12) Patent Application Publication
(10) Pub. No.: US 2012/0069767 A1
(43) Pub. Date: Mar. 22, 2012

(54) METHOD AND AN ARRANGEMENT FOR A MOBILE TELECOMMUNICATIONS NETWORK

(76) Inventor: Tor Björn Minde, Gammelstad (SE)

(21) Appl. No.: 13/320,764

(22) PCT Filed: Jun. 23, 2009
(86) PCT No.: PCT/SE2009/050791

§ 371 Date: Nov. 16, 2011

(51) Int. Cl. H04W 24/00

(52) U.S. Cl. 370/252

(57) ABSTRACT

The present invention relates to a user device and a method for providing a solution for how to make automatic update of the presence state in a mobile device in a communication service e.g. a buddy list in a chat service. The solution is based on that the user device analyzes the background ‘“noise” 5 (sound) of the audio environment, and utilizes this analysis for determining a presence state of the user of the mobile device.

### TECHNICAL FIELD

The present invention relates to methods and arrangements in a mobile telecommunication system and in particular to a solution for automatically detecting and updating presence state in an IP Multimedia Subsystem or a similar communication system.

### BACKGROUND

The Internet Protocol (IP) Multimedia Subsystem (IMS) is an architecture for delivering IP multimedia services in telecommunication networks. The IMS 101 may be connected to fixed 102, 104 or wireless networks 103 as illustrated in FIG. 1 and controls IP based services provided by various content providers. Hence, IMS is the convergence of wireless and IP technology.

The user can connect to an IMS network in various ways, by using Session Initiating Protocol (SIP). IMS terminals such as mobile phones, personal digital assistants PDAs and laptops can register directly on an IMS network, even when they are roaming in another network or country. The only requirement is that they can use IP and run Session Initiation Protocol (SIP) user agents. As illustrated in FIG. 1, fixed access, mobile access (e.g. 3G, 4G systems) and wireless access (e.g. WLAN, WiMAX) are all supported. Other phone systems like plain old telephone service (POTS—the old analogue telephones), H.323 and non IMS-compatible VoIP systems, are supported through gateways.

Presence is a service which can be provided by the IMS. Presence allows a user to subscribe to presence information regarding other users, wherein the presence information is a status indicator that conveys ability and willingness of a potential communication in computer and telecommunications networks. User's clients provide presence information (presence state) via a network connection to the presence service. The states are stored in what constitutes personal availability records and can be made available for distribution to other users (called watchers) to convey availability for communication. Presence information has wide application in many communication services. It is one of the innovations driving the popularity of instant messaging or recent implementations of voice over IP clients.

Hence, a user client may publish a presence state to indicate its current communication status. This published state informs others that wish to contact the user of his availability and willingness to communicate. The most common use of presence today is to display an indicator icon on instant messaging clients, typically from a choice of graphic symbol with an easy-to-convey meaning, and a list of corresponding text descriptions of each of the states.

By employing presence and messaging software the users are able to create “buddy lists” which indicate the current status of the people in the list. When a user is indicated as available, it is e.g. possible to use an Instant Messaging (IM) service to send and receive real-time messages. Thus, the presence information can be used to select the most appropriate time for starting a communication, as well as the most suitable communication tool. Examples of presence status information are “I am in a meeting”, “I am on-line”, “I am off-line”, “I am Busy”, “Do not disturb”, etc. Further information about what communication tools a user prefers may also be provide such as “Call me on my mobile”, “free for chat”, “away”, “do not disturb”, “out to lunch”. Such states exist in many variations across different modern instant messaging clients. Current standards support a rich choice of additional presence attributes that can be used for presence information, such as user mood, location, or free text status.

In most situations, communication is initiated from a contact list. An end user can create and manage a contact list by means of functionalities provided by a serving node in the IMS. These lists are stored in the IMS network and can be reused by a user's different applications.

One problem is that manual updates of the presence state are troublesome for the user. It is difficult to remember to change state when switching between different tasks and moving around. The user has to manually select a state.

In order to maintain the presence information updated, it is desired to be able to update the presence status information automatically.

Some automatic update functionality is available in PCs or desk-top based presence functions. Leaving the PC idle for a couple of minutes can be detected and an update of the presence state may be performed. Detection of user activity can be done by checking if other software is running like document handling, games etc. Other possible solutions are to use context information such as position, calendar information to compute a presence state.

WO 2007/037679 and US 2005/0228882 mention that audio can be used for determining a presence state but it is not disclosed how that is achieved.

### SUMMARY

The objective problem of the present invention is to provide a solution for how to make automatic update of the presence state in a mobile device in a communication service e.g. a buddy list in a chat service.

The objective problem is solved by the present invention by letting the mobile device analyze the background ‘“noise” (sound) of the audio environment, and utilize this analysis for determining a presence state of the user of the mobile device. A solution for how the analysis and the determination of the presence state is performed is presented by this invention.

According to a first aspect of the present invention a method in a user device adapted to communicate with a mobile telecommunication network is provided. In the method, an audio signal representing surrounding background noise is received and spectrum vector representing at least the surrounding background noise are derived. The derived spectrum vector is classified into a pre-defined vector class by spectrum classifier and a presence state is determined at least based on the pre-defined vector class to which the spectrum vector belongs. Then the determined presence state is sent to a presence server.

According to a second aspect of the present invention, a user device, adapted to communicate with a mobile telecommunication network is provided. The user device comprises a receiver for receiving an audio signal representing surrounding background noise and a spectrum analyzer for deriving spectrum vector representing at least the surrounding background noise. Moreover, the user device comprises a classifier for classifying the derived spectrum vector into a pre-defined vector class by spectrum classifier and a presence state calculator for determining a presence state at least based on the pre-defined vector class to which the spectrum vector belongs. In addition, the user device comprises a transmitter for sending the determined presence state to a presence server.

An advantage with the present invention is that, since the presence state is calculated automatically, the users hurdle to use the presence service is removed. Thus, there is no manual trouble to remember updating the state for the user.

### BRIEF DESCRIPTION OF THE DRAWINGS

FIG. 1 illustrates a scenario wherein an embodiment of the present invention is implemented.

FIG. 2 illustrates schematically a mobile device according to an embodiment of the present invention.

FIG. 3 illustrates schematically a mobile device according to a further embodiment of the present invention.

FIG. 4 is a flowchart of the method according to embodiments of the present invention.

### DETAILED DESCRIPTION

The present invention will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements.

Moreover, those skilled in the art will appreciate that the means and functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

The basic idea of the embodiments of the present invention is to let the mobile device analyze the background “noise” of the audio environment, and utilize this analysis for determining a presence state.

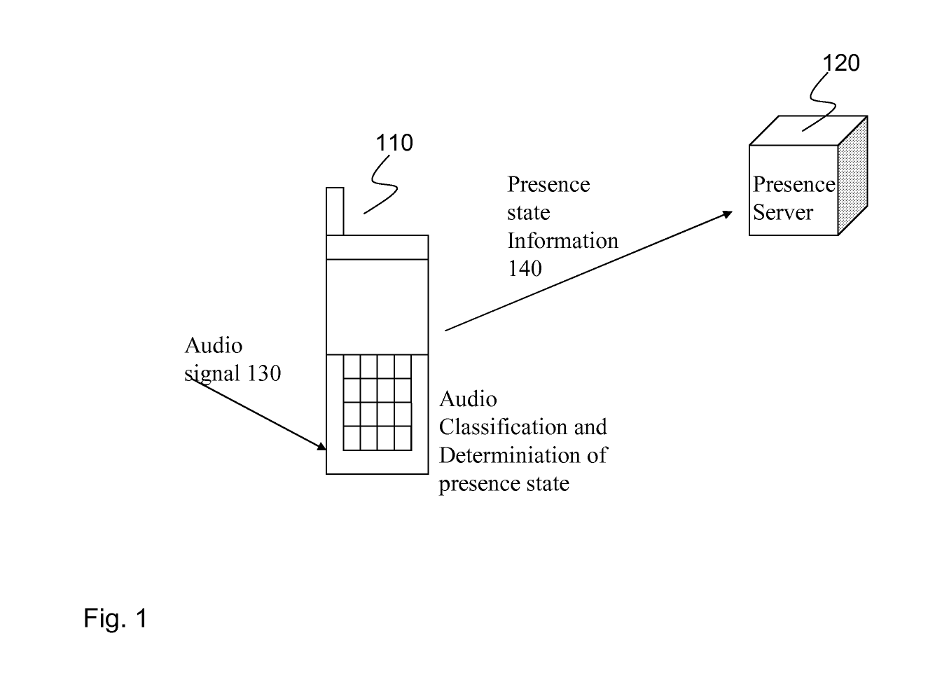

As illustrated in FIG. 1, a continuous audio signal 130 is received at the microphone 298 of the mobile device 110. This audio signal 130 is analyzed and a presence state is determined based at least on this analysis. The determined presence state 140 is then sent to a presence server 120 in the IMS system.

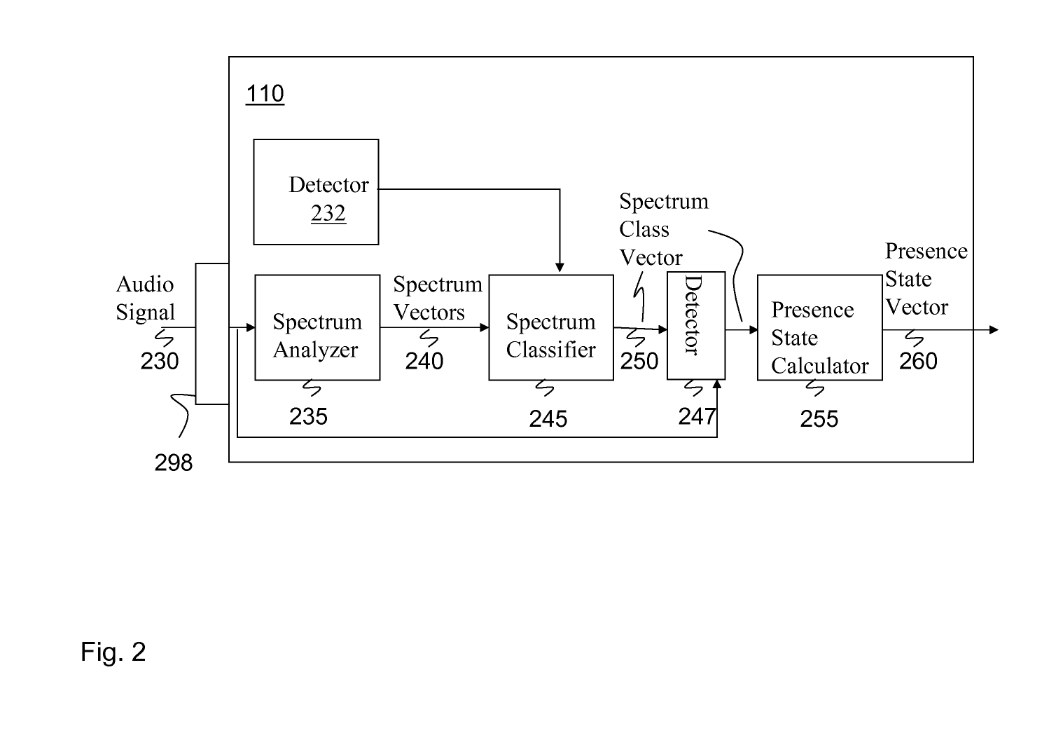

Turning now to FIG. 2 illustrating how the audio signal 230 is analyzed to determine the presence state according to one embodiment.

The automatic audio-based presence state determination comprises three main parts. An audio environment spectrum analyzer 235, an audio spectrum classifier 245 and a presence state calculator 255.

The spectrum analyzer calculates spectrum vectors 240, i.e. spectrum representations, of the audio signal from the microphone. The audio signal is the time series of audio samples received from an A/D converter (not shown) of the mobile device. The spectrum vectors are representations e.g. of the current short-term spectrum, long-term spectrum and spectrum changes. The spectrum classifier 245 classifies the audio spectrum vector into classes representing the environment. These classes are indicated in the spectrum class vectors 250. Further, the presence state calculator 255 calculates the current presence state 260 and creates a presence state vector 260 comprising the current presence state, which is sent to a presence server in the IMS network.

According to a further embodiment, the user device 110 comprises a first detector 232 for detecting user activity. In this embodiment, the spectrum classifier 245 is configured to derive spectrum class vectors representing at least the surrounding background noise and the detected user activity.

Furthermore, the user device 110 may comprise a second detector 247 which is configured to detect changes of the background noise. The presence state calculator 255 is configured to determine the presence state based at least on the spectrum vector and the detected changes.

The spectrum analyzer can use different kinds of spectrum representations such as Fourier transforms, LPC spectrum models (AR or ARMA) or Cepstrums. This is further explained in the appendix. The classification can also be of different kinds like neural networks, naive Bayes classifiers, k-nearest neighbor and support vector machines etc.

The presence state is a model with a low-pass averaging function. The output presence state consists of a vector with classes representing different aspects of the background environment. The different parts of the presence state vector are low pass filtered in time in the presence state model.

The audio environment may be classified into pre-defined presence state classes like activity, occupation, environment and change. Examples of activity classes are meeting, walking, standing, driving, cycling, sitting etc. Occupation classes are for example talking, editing, eating, breaking, watching, phoning, working etc. Environment classes are for example office room, office hallway, outdoor town, outdoor forest, outdoor street, indoor mall, indoor home, subway, car, airplane etc. Changes in the audio environment (i.e. of the background noise) are classified by the transfer from one state to another possible state.

The classifier is trained to a large data set containing all states of the presence model. I.e., the audio environment for the many different possible classes of the presence state is recorded, manually classified and used as training material.

A personal profile can be used, but is not needed, to define a layered policy. Together with the personal profile the user can define rules (policies) how the presence state should be used. A more detailed presence state gives more information for other users and more possibilities how to handle presence for the user. For example private contacts like friends and family might have a certain priority also in a business setting managers, colleagues and sub-ordinates may have defined priorities. As an example, if a watcher (i.e. another user) has higher priority the layered policy defines how much detail of the presence state that is revealed to the watcher. Hence the user can define that family and friends are allowed to monitor that the user is in a car or in the subway, but other watchers may only be allowed to monitor that the user is away or on the move. As a further example, the manager may be allowed to monitor if the user is on the phone, in a meeting or in the coffee room while other watchers only can see if the user is busy or free.

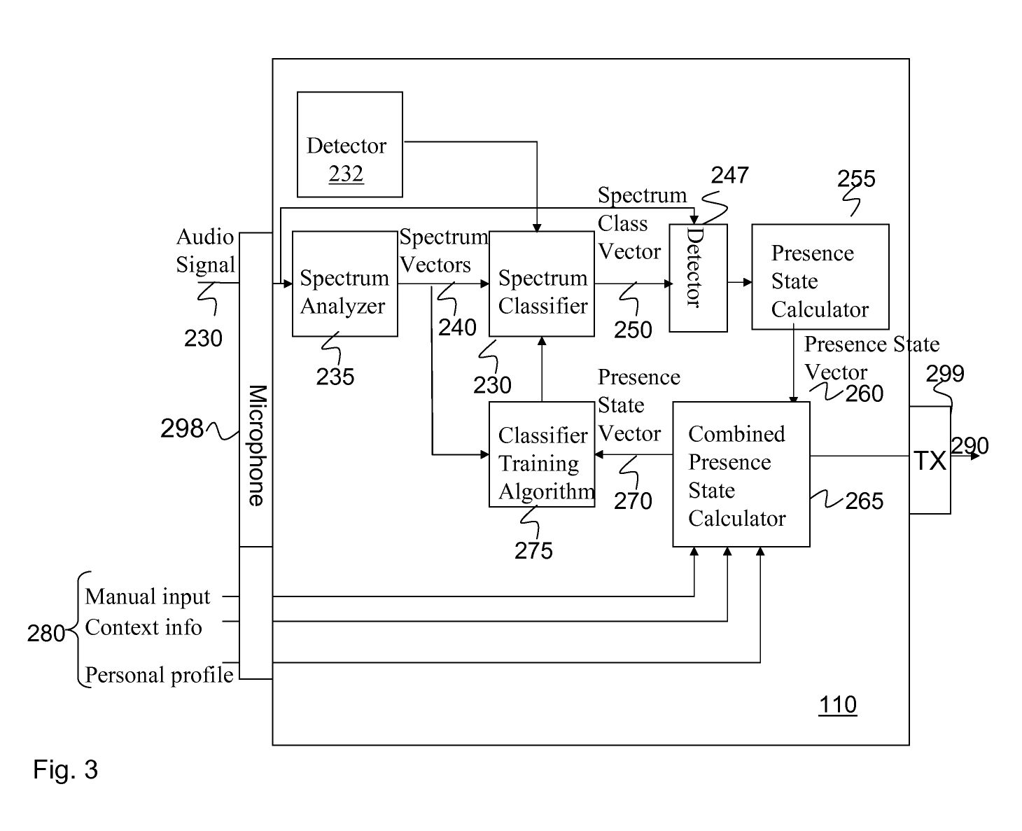

The automatic detection of the user's presence state can be combined with both manual and other context dependent presence state information. FIG. 3 illustrates a mobile device according to an embodiment of the present invention where this information 280 also can be combined with the personal profile to calculate the presence state vector 290. The arrangement of FIG. 3 discloses the arrangement shown in FIG. 2 with the exception that it comprises classifier training algorithm 275 and a combined presence state calculator 265.

The classifier training algorithm 275 improves the classifying of the spectrum classifier 230 by using pairs of spectrum vectors and presence state vectors. This is achieved by using recorded audio files which are manually tagged with different present state classes. Spectrum vectors are calculated from the audio files and the manual tagged present state is used as the correct output from the classifier as supervised training material.

The combined presence state calculator 265 combines the automatic calculated presence state 260 with manual input state 280, context information 280 and/or the personal profile 280. Manual input can consists of text, simple on/off-line status and prompted user feedback. Context information may consist of positioning information, calendar information or other software presence state information. The personal profile contains user defined rules how the presence state information can be used and priorities for different watchers (users) as explained above.

The user can also be asked to confirm the calculated presence state. This can also be used to train the spectrum classifier on-line which will improve the presence state calculator and make the calculation better suited to the user normal audio environment. Furthermore, the user can be prompted about the detected presence state and accept or reject the automatic detection which will improve the usability.

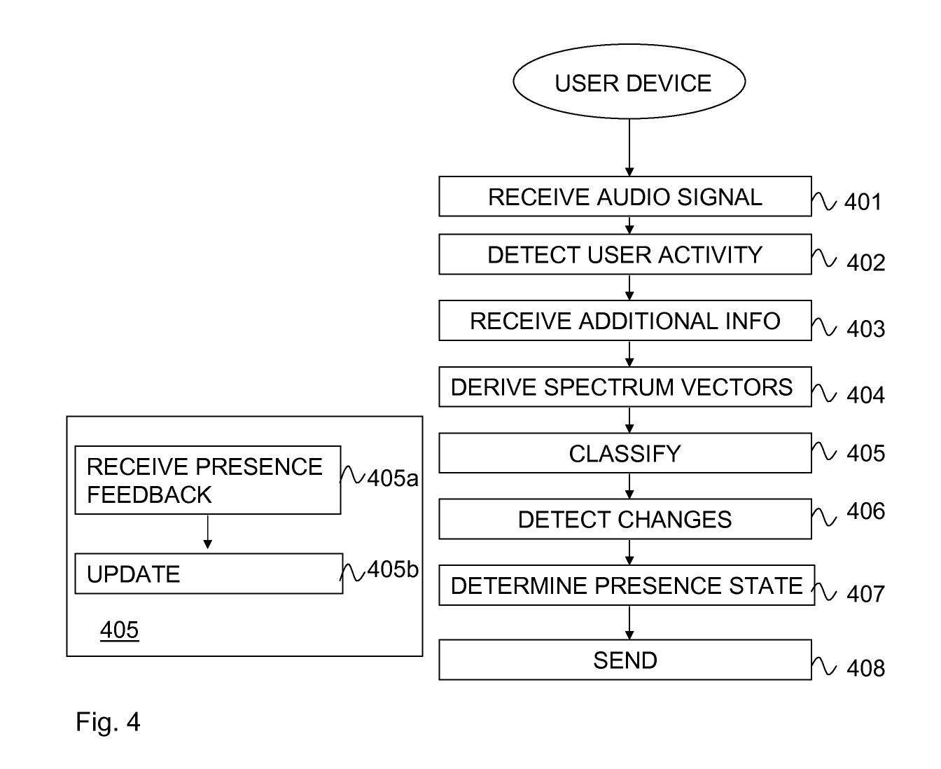

The embodiments of the present invention also relates to a method, which is illustrated by the flowchart of FIG. 4.

In step 401, an audio signal representing surrounding background noise is received. In addition the user activity may be detected 402 and additional presence state information, e.g. information manually entered by the user, context information, personal profile information, may be received 403. A spectrum vector representing at least the surrounding background noise are derived in step 404 and the derived spectrum vector is classified 505 into a pre-defined vector class by spectrum classifier at least based on the derived spectrum vector. In an optional step, step 406, changes of the background noise may be detected 406, e.g. that the user leaves a car. A presence state is determined 407 at least based on the pre-defined vector class to which the spectrum vector belongs. The determined presence state is then sent (published) 408 to a presence server.

In order to improve the spectrum classifier, a training algorithm may be used. If the training algorithm is used the classifying step 405 comprises the further steps of: receiving (405a) presence state feedback from a previously determined presence state, and updating (405b) the spectrum classifier based on the received presence state feedback which is further explained above.

A background of the spectrum analysis which can be used in the present invention, is provided in the Appendix. It should however be understood that the Appendix is a part of the patent application text.

The present invention is not limited to the above-described preferred embodiments. Various alternatives, modifications and equivalents may be used. Therefore, the above embodiments should not be taken as limiting the scope of the invention, which is defined by the appending claims.

### APPENDIX

### Spectrum Analysis Background

Spectrum analysis means decomposing something complex into simpler, more basic parts. There is a physical basis for modeling sound as being made up of various amounts of all different frequencies. Any process that quantifies the various amounts vs. frequency can be called spectrum analysis. It can be done on many short segments of time, or less often on longer segments, or just once for a deterministic function.

The Fourier transform of a function produces a spectrum from which the original function can be reconstructed (aka synthesized) by an inverse transform, making it reversible. In order to do that, it preserves not only the magnitude of each frequency component, but also its phase. This information can be represented as a 2-dimensional vector or a complex number, or as magnitude and phase (polar coordinates). In graphical representations, often only the magnitude (or squared magnitude) component is shown. This is also referred to as a power spectrum.

Because of reversibility, the Fourier transform is called a representation of the function, in terms of frequency instead of time, thus, it is a frequency domain representation. Linear operations that could be performed in the time domain have counterparts that can often be performed more easily in the frequency domain.

The Fourier transform of a random (aka stochastic) waveform (aka noise) is also random. Some kind of averaging is required in order to create a clear picture of the underlying frequency content (aka frequency distribution). Typically, the data is divided into time-segments of a chosen duration, and transforms are performed on each one. Then the magnitude or (usually) squared-magnitude components of the transforms are summed into an average transform. This is a very common operation performed on digitized (aka sampled) time-data, using the discrete Fourier transform (see Welch method).

1.1 LPC background

Linear predictive coding (LPC) is a tool used mostly in audio signal processing and speech processing for representing the spectral envelope of a digital signal of speech in compressed form, using the information of a linear predictive model. It is one of the most powerful speech analysis techniques, and one of the most useful methods for encoding good quality speech at a low bit rate and provides extremely accurate estimates of speech parameters.

LPC starts with the assumption that a speech signal is produced by a buzzer at the end of a tube (voiced sounds), with occasional added hissing and popping sounds (sibilants and plosive sounds). Although apparently crude, this model is actually a close approximation to the reality of speech production. The glottis (the space between the vocal cords) produces the buzz, which is characterized by its intensity (loudness) and frequency (pitch). The vocal tract (the throat and mouth) forms the tube, which is characterized by its resonances, which are called formants. Hisses and pops are generated by the action of the tongue, lips and throat during sibilants and plosives.

LPC analyzes the speech signal by estimating the formants, removing their effects from the speech signal, and estimating the intensity and frequency of the remaining buzz. The process of removing the formants is called inverse filtering, and the remaining signal after the subtraction of the filtered modeled signal is called the residue.

Because speech signals vary with time, this process is done on short chunks of the speech signal, which are called frames; generally 30 to 50 frames per second give intelligible speech with good compression.

### 1.2 Cepstrum Background

A cepstrum (pronounced / [symbol] /) is the result of taking the Fourier transform (FT) of the decibel spectrum as if it were a signal. Its name was derived by reversing the first four letters of “spectrum”. There is a complex cepstrum and a real cepstrum.

The cepstrum was defined in a 1963 paper (Bogert et al.). It may be defined
verbally: the cepstrum (of a signal) is the Fourier transform of the logarithm (with unwrapped phase) of the Fourier transform (of a signal). Sometimes called the spectrum of a spectrum.
mathematically: cepstrum of signal=FT(log(|FT(the signal)|)+j2 πm) (where m is the integer required to properly unwrap the angle or imaginary part of the complex log function)
algorithmically: signal→FT→abs( )→log→phase unwrapping→FT→cepstrum

The “real” cepstrum uses the logarithm function defined for real values. The complex cepstrum uses the complex logarithm function defined for complex values.

The complex cepstrum holds information about magnitude and phase of the initial spectrum, allowing the reconstruction of the signal. The real cepstrum uses only the information of the magnitude of the spectrum.

### 1.3 Classification Background

Statistical classification is a procedure in which individual items are placed into groups based on quantitative information on one or more characteristics inherent in the items (referred to as traits, variables, characters, etc) and based on a training set of previously labeled items.

Formally, the problem can be stated as follows: given training data produce a classifier which maps an object to its classification label. For example, if the problem is filtering spam, then is some representation of an email and y is either “Spam” or “Non-Spam”.

While there are many methods for classification, they all attempt to solve one of the following mathematical problems
The first is to find a map of a feature space (which is typically a multi-dimensional vector space) to a set of labels. This is equivalent to partitioning the feature space into regions, then assigning a label to each region. Such algorithms (e.g., the nearest neighbour algorithm) typically do not yield confidence or class probabilities, unless post-processing is applied. Another set of algorithms to solve this problem first apply unsupervised clustering to the feature space, then attempt to label each of the clusters or regions.
The second problem is to consider classification as an estimation problem, where the goal is to estimate a function of the form

P(class|\vec{x})=f(\vec{x};\vec{θ})

where the feature vector input is \vec{x}, and the function f is typically parameterized by some parameters \vec{θ}. In the Bayesian approach to this problem, instead of choosing a single parameter vector \vec{θ}, the result is integrated over all possible thetas, with the thetas weighted by how likely they are given the training data D:

P(class|\vec{x})=∫f(\vec{x};\vec{θ})P(\vec{θ}|D)d\vec{θ}
The third problem is related to the second, but the problem is to estimate the class-conditional probabilities P(\vec{x}|class) and then use Bayes' rule to produce the class probability as in the second problem.

Examples of classification algorithms include:

Linear classifiers
Fisher's linear discriminant
Logistic regression
Naive Bayes classifier

### Perceptron

Quadratic classifiers
k-nearest neighbor

### Boosting

Decision trees
Neural networks
Bayesian networks
Support vector machines
Hidden Markov models

An intriguing problem in pattern recognition yet to be solved is the relationship between the problem to be solved (data to be classified) and the performance of various pattern recognition algorithms (classifiers). Van der Walt and Barnard (see reference section) investigated very specific artificial data sets to determine conditions under which certain classifiers perform better and worse than others.

Classifier performance depends greatly on the characteristics of the data to be classified. There is no single classifier that works best on all given problems (a phenomenon that may be explained by the No-free-lunch theorem). Various empirical tests have been performed to compare classifier performance and to find the characteristics of data that determine classifier performance. Determining a suitable classifier for a given problem is however still more an art than a science.

The most widely used classifiers are the Neural Network (Multi-layer Perception), Support Vector Machines, k-Nearest Neighbours, Gaussian Mixture Model, Gaussian, Naive Bayes, Decision Tree and RBF classifiers.

1. A method in a user device adapted to communicate with a mobile telecommunication network, the method comprises the steps of:
receiving an audio signal representing surrounding background noise,
deriving a spectrum vector representing at least the surrounding background noise,
classifying the derived spectrum vector into a pre-defined vector class by spectrum classifier,
determining a presence state in response to the pre-defined vector class to which the spectrum vector belongs, and
sending the determined presence state to a presence server.

2. The method according to claim 1, wherein the method comprises the further step of:
detecting user activity,
wherein the classifying step comprises deriving spectrum class vector representing at least the surrounding background noise and the detected user activity.

3. The method according to claim 1, wherein the method comprises the further step of:
detecting changes of the background noise,
wherein the determination of the presence state is responsive to the spectrum vector and the detected changes.

4. The method according to claim 1, wherein the method comprises the further steps of:
receiving additional presence state information, and
determining the presence state responsive to the pre-defined vector class to which the spectrum vector belongs and the received additional presence information.

5. The method according to claim 1, wherein the additional presence state information comprises context information.

6. The method according to claim 1, wherein the additional presence state information comprises personal profile information.

7. The method according to claim 1, wherein the additional presence state information comprises information entered manually by the user of the user device.

8. The method according to claim 1, wherein the classifying step comprises the further steps of:
receiving presence state feedback from a previously determined presence state, and
updating the spectrum classifier response to the received presence state feedback.

9. A user device, adapted to communicate with a mobile telecommunication network, the user device comprising:
a receiver for receiving an audio signal representing surrounding background noise;
a spectrum analyzer for deriving spectrum vector representing at least the surrounding background noise;
a classifier for classifying the derived spectrum vector into a pre-defined vector class by spectrum classifier;
a presence state calculator for determining a presence state in response to the pre-defined vector class to which the spectrum vector belongs; and a transmitter for sending the determined presence state to a presence server.

10. The user device according to claim 9, wherein:
the user device further comprises a first detector for detecting user activity, and
the classifier is configured to derive spectrum vector representing at least the surrounding background noise and the detected user activity.

11. The user device according to claim 9, wherein:
the user device comprises a second detector which is configured to detect changes of the background noise, and
the presence state calculator is configured to determine the presence state in response to the spectrum vector and the detected changes.

12. The user device according to claim 9, wherein:
the receiver is further configured to receive additional presence state information, and
the presence state calculator is configured to determine the presence state responsive to the pre-defined vector class to which the spectrum vector belongs and the received additional presence information.

13. The user device according to claim 9, wherein the additional presence state information comprises context information.

14. The user device according to claim 9, wherein the additional presence state information comprises personal profile information.

15. The user device according to claim 9, wherein the additional presence state information comprises information entered manually by the user of the user device.

16. The user device according to claim 9, wherein the classifier is further configured to determine the presence state responsive to presence state feedback from a previously determined presence state by using a classifier training unit, and to update the vector class of the classifier in response to the received presence state feedback.
